(19) United States
(12) Patent Application Publication
(10) Pub. No.: US 2015/0204274 A1
(43) Pub. Date: Jul. 23, 2015

(54) RESIN TRANSFER MOLDED ROCKET MOTOR NOZZLE

(71) Applicant: Raytheon Company, Waltham, MA (US)

(72) Inventor: Gray E. Fowler, Allen, TX (US)

(21) Appl. No.: 14/313,017

(22) Filed: Jun. 24, 2014

Related U.S. Application Data
(60) Provisional application No. 61/929,936, filed on Jan. 21, 2014.

(51) Int. Cl. F02K 9/97; B29C 70/78

(52) U.S. Cl. CPC F02K 9/97; B29C 70/78; B29L 2031/748

(57) ABSTRACT

A resin transfer molding process is used to manufacture a fiber reinforced composite for a rocket motor nozzle, the composite including a benzoxazine resin and a reinforcing fabric.

### FIELD OF THE INVENTION

The present invention related to missiles and rocket motors. More specifically, the present invention relates to rocket motor nozzles.

### DESCRIPTION OF THE RELATED ART

Rocket motors typically create thrust by expelling a high-temperature exhaust produced by the combustion of solid or liquid propellants through a nozzle. The hot gas (or liquid or plasma) exhaust exits from the combustion chamber through a narrow opening (or “throat”) into the nozzle. The nozzle is shaped such that it causes the gas to expand and accelerate, converting the thermal energy into kinetic energy. As the gas expands, it exerts pressure against the walls of the nozzle, forcing the missile in one direction while the gas accelerates in the opposite direction.

Conventional tactical missile solid rocket motors have utilized composite nozzles fabricated using silica fabrics preimpregnated with phenolic resin. However, phenolics are difficult to process in thick sections due to condensation cure by-products. Nozzles are typically hundreds to thousands of layers thick, making it impossible to remove the void forming condensation by-products. This often results in poor laminate quality, and unpredictable nozzle performance.

### SUMMARY OF THE INVENTION

The present invention, in one aspect, is directed to a resin transfer molding (RTM) process for manufacturing rocket motor nozzles using silica fabric and benzoxazine resin. The RTM process is a cost saving process when compared to the processing of the standard prepreg processes, mostly due to reduced process steps and reduced hands-on labor. In conventional nozzle manufacturing, the different components of the nozzle are molded and cured separately. The separately formed components are then precision machined in a secondary operation and then bonded in place with the nozzle throat material and housing in a secondary process. The RTM process of the present invention eliminates the secondary machine and bonding operations, which in turn reduces cycle time and cost while increasing the finished part quality by reducing defect opportunities. In addition, the raw material costs are typically less than those for hand layup because dry performs are used rather than traditional prepregs.

The net shape molded RTM process used in the manufacture of nozzles may require the extensive use of high vacuum. Most commercially available phenolics are heavily laden with solvents, which prohibits the use of vacuum. Benzoxazine based resins meet the criteria of the burn resistance of phenolic resin and the processing characteristics needed for RTM.

Benzoxazine thermoset is a true addition cure mechanism that creates no volatiles during the heat applied cure process. Benzoxazine has non-combustible burn properties, which are required for rocket nozzles. The benzoxazine resin composites fabricated by RTM show higher fiber volume, better performance, lower void volumes, easier processing and much high quality composite laminates than those conventionally made using phenolic resins. In addition, production cycle time is lower and more reliable, which results in cost reduction.

In one aspect of the invention there is provided a method of producing a composite rocket motor nozzle that includes the steps of: forming a near net shape three-dimensional preform comprising a first reinforcement material in a first region and a second reinforcement material in a second region, the first reinforcement material being different than the second reinforcement material; positioning the three-dimensional preform in a mold cavity of a mold; introducing a matrix resin into the preform within the mold cavity and molding the preform and the resin to form the composite rocket motor nozzle having a final shape and final dimensions.

The method may further include the step of a solid nozzle throat insert within the mold cavity prior to introducing the matrix resin.

In one embodiment, the first reinforcement material includes silica fiber or ceramic fiber.

In one embodiment, the second reinforcement material includes carbon fiber.

In one embodiment, the matrix resin is benzoxazine.

The fiber angle and fiber volume of the first reinforcement material in the first region may be selected independently of the fiber angle and fiber volume of the second reinforcement material in the second region.

In another aspect of the invention, there is provided a near net shape composite rocket motor nozzle precursor that includes: a three-dimensional nozzle preform portion formed of a resin impregnable first reinforcement material; a three-dimensional dome preform portion formed of a resin impregnable second reinforcement material; an annular narrow throat preform portion between the nozzle portion and the dome portion, the throat portion formed of a resin impregnable third reinforcement material and configured to accept a solid throat insert; and a solid throat insert positioned inside of the narrow throat preform portion; wherein at least two of the first reinforcement material, second reinforcement material and third reinforcement material comprise different fiber material.

The precursor may further include a metal housing surrounding the nozzle preform portion, the dome preform portion and the throat preform portion.

In one embodiment, the first reinforcement material includes silica fiber or ceramic fiber. The second reinforcement material may include silica fiber or ceramic fiber. The third reinforcement material may include carbon fiber.

In one embodiment, the solid throat insert is constructed of silicon carbide or tungsten.

In one embodiment of the precursor, the fiber angle and fiber volume of the nozzle preform portion is selected independently of the fiber angle and fiber volume of the throat preform portion and the fiber angle and fiber volume of the dome preform portion.

In one embodiment of the precursor, the fiber angle and fiber volume of the dome preform portion is selected independently of the fiber angle and fiber volume of the throat preform portion and the fiber angle and fiber volume of the nozzle preform portion.

In a further aspect of the invention, there is provided a composite rocket motor nozzle that includes: a nozzle portion including silica or ceramic fibers in a benzoxazine matrix; a narrow throat portion including carbon fibers in a benzoxazine matrix; and a dome portion including silica or ceramic fibers in a benzoxazine matrix; wherein the nozzle portion, the throat portion and the dome portion are simultaneously molded in a resin transfer molding process to form a single composite rocket motor nozzle structure.

### BRIEF DESCRIPTION OF THE DRAWINGS

FIG. 1 is a simplified schematic of an illustrative missile with a rocket motor nozzle in accordance with an illustrative embodiment of the present invention.

FIG. 2 is a cross-sectional view of a nozzle structure that includes a SiC throat insert in accordance with an illustrative embodiment of the present invention.

FIG. 3 is a photograph of a benzoxazine/silica fiber composite produced in accordance with an embodiment of the present invention.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### DETAILED DESCRIPTION

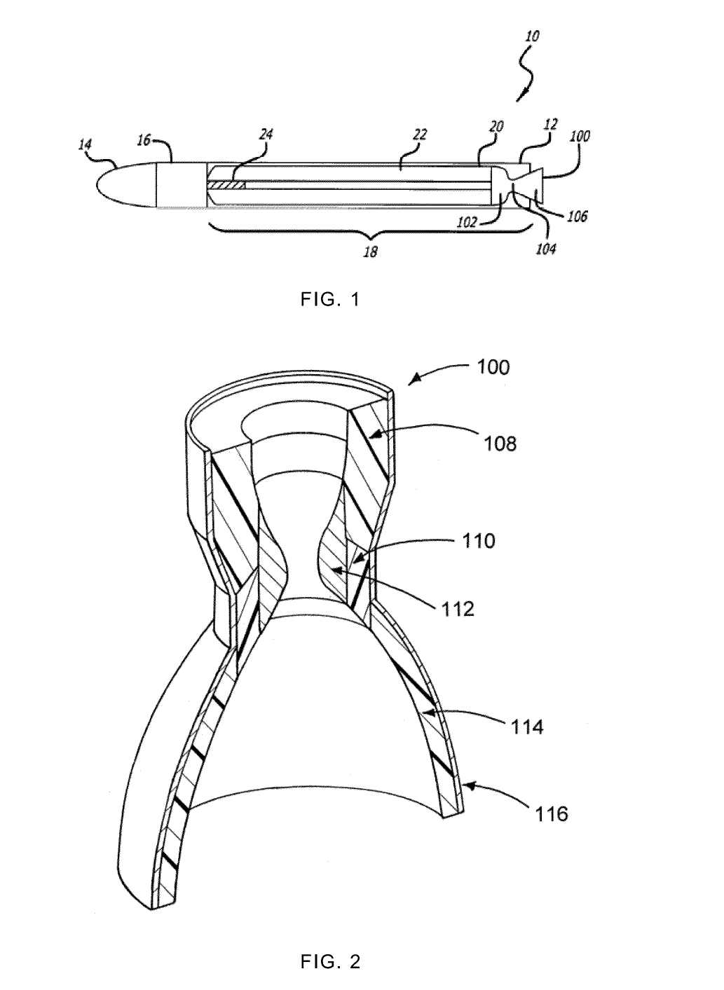

FIG. 1 is a simplified schematic of an illustrative missile 10 with a rocket motor nozzle 100 designed in accordance with an illustrative embodiment of the present invention. The illustrative missile 10 includes a missile body 12, which houses a sensor 14 for locating a target, a guidance system 16 for guiding the missile 10 toward the target, and a rocket motor 18 for providing thrust to increase the range of the missile 10. The rocket motor 18 includes a combustion chamber 20 filled with a propellant 22 that is ignited by an igniter 24 controlled by the guidance system 16.

The rocket motor 18 also includes a novel integrated dome and nozzle structure 100. The dome 102 portion of the dome/nozzle structure forces the exhaust gas produced by the combustion of the propellant 22 to exit the combustion chamber 20 through a narrow throat 104 and out the nozzle 106, which is shaped such that it causes the gas to expand and accelerate, thereby providing thrust for the missile 10. In the illustrated embodiment, the dome and nozzle structure 100 is integrally manufactured with a single high temperature resin system. In alternative embodiments, the dome and nozzle assemblies are separate structures.

The resin property of primary interest for the nozzle application is not very high temperature capability, but the burn properties referred to as char yield. The main reason that phenolics have been used in rocket motor nozzle applications for more than fifty years is because when exposed to the temperature extremes of the hot gas of a rocket, the resin does not burn and forms a char which then insulates the laminate from direct heat exposure. Because of this char property and the ability to retain some strength when relatively hot (400-600° F.) combined with the low cost of phenolics, they have been the choice material despite all the negative processing issues inherent with the chemistry.

While good structural properties at high temperature are beneficial, they are not the primary driver in choosing a material for use in the rocket motor nozzle environment, which requires different considerations than for typical composite structures. Specifically, regardless of the glass transition temperature (Tg) of the resin, the nozzles gases will be at least 2500-3000° F. higher than the expected high temperature capability of any resin system. In addition, most tactical rocket motors burn less than 8-9 seconds, discounting the importance of the need of high temperature structural properties. There simply is not enough time to saturate the entire laminate thickness with very high temperature. Furthermore, the importance of the silica fiber as the reinforcing fiber and the laminate quality play an important part in the nozzles performance, regardless of resin choice. The nozzle has Mach 3+ abrasive hot gas that the silica fiber withstands much better than any resin.

Suitable resins for use in rocket motor nozzles must have certain properties. The resin cannot self sustain burn. Any polymer exposed to the extreme gas temperatures will burn, and what is required is a char, and not having the nozzle material become fuel for the fire. In addition, higher temperature physical properties are beneficial. The higher the temperature capability, the lower the presumed risk. 100° F. capability is not as low risk as 350° F. capability, but all resins are far beyond their temperature capability. Examples of suitable resins include phenolics, polyimides and benzoxazines.

In one embodiment, in addition to high char yield, suitable resins for use in rocket motor nozzles are easily resin transfer molded to produce a low cost nozzle.

The rocket motor nozzle of the present invention is constructed of a fiber reinforced composite material. In one embodiment, the composite material includes reinforcing fibers and a benzoxazine resin. Benzoxazines are a class of resins that are generally formed by the reaction of a phenol, primary amine and formaldehyde or paraformaldehyde. The benzoxazine may be polymerized by simple heating to open the oxazine ring. This leads to the formation of a chemical bond between the phenolic groups. Cross-linked (i.e., thermoset) polybenzoxazines generally require multi-functional benzoxazine monomers (i.e., they contain more than two reactive sites). Generally, cross-linked polybenzoxazines are formed from benzoxazine monomers having more than one benzoxazine ring. Exemplary benzoxazine resins include, but are not limited to, XU3560, LMB6493, LMB6490 and LMB6492 (all available from Huntsman Corporation) and Epsilon 99110 and Epsilon 99120 (both available from Henkel Corporation), or a combination of two or more thereof.

The reinforcing fibers suitable for use in the composite include fibers made of carbon, silica, quartz and aramid. The fibers may include long fibers that have been pulled into alignment in one direction, woven fabrics of continuous reinforcing fibers, discontinuous short fibers and nonwoven fabrics.

The benzoxazine containing fiber reinforced composite may be produced by method involving direct impregnation of the reinforcement fiber with the benzoxazine resin composition, including hand lay-up methods, filament winding methods, pultrusion methods, resin injection molding methods, and resin transfer molding methods.

In one embodiment, the rocket motor nozzle is manufactured using a net shape vacuum RTM process. In the net shape RTM process, pre-formed sections of the molded nozzle having various fiber architectures and preform geometries are placed into a tool and the entire preform is resin transfer molded. The net shape RTM process allows for the integration of inserts by placing the insert(s) into the mold prior to introduction of the resin into the mold.

Referring to FIG. 2, the rocket motor nozzle 100 includes nozzle composite region 108, throat composite region 110, throat insert 112 and dome composite region 114 within metal housing 116. The RTM molding process can combine different reinforcing fibers and fabrics as dry fiber near net shape pre-forms with a solid nozzle throat insert and mold a nozzle in a single RTM process step.

Nozzle composite region 108, located at the exit of the rocket motor nozzle 100, is constructed of a thermally insulative fabric placed at specific angles, commonly referred to as “shingling”. In the net shape RTM method, the insulative fiber fabric, such as silica or ceramic, is pre-formed in a precision tool to control both the fiber angle and the fiber volume in a near net 3D shape. The selected fiber type, fiber weave and shingle angle is independent of the requirements of any other region of the rocket motor nozzle.

Throat composite region 110 includes a fiber reinforcement having higher temperature capability, such as PAN-based carbon fiber (polyacrylonitrile). In the net shape RTM method, the composite pre-form for the throat composite area 110 is prepared in a precision tool to control both the fiber angle and the fiber volume in the throat composite area 110 without regard to the requirements of the nozzle composite region 108 or any other region.

Throat insert 112 is constructed of a solid material such as metal, carbon-carbon coated with metal, high temperature ceramic or refractory material. For example, the throat insert may be constructed of silicon carbide or tungsten. The throat insert in integrated into the rocket motor nozzle during the RTM process.

Dome composite region 114 includes a thermally insulative fabric placed at specific angles, commonly referred to as “shingling”. In the net shape RTM method, the insulative fiber fabric, such as silica or ceramic, is pre-formed in a precision tool to control both the fiber angle and the fiber volume in a near net 3D shape. The selected fiber type, fiber weave and shingle angle is independent of the requirements of any other region of the rocket motor nozzle.

Metal housing 116 may be constructed of titanium, steel, aluminum or any other rigid housing material. The rigid housing can be incorporated into the molding process of the rocket nozzle.

The net shape RTM process provides several advantages over the conventional prepreg hand wrapping construction methods and materials. The RTM process eliminates delamination as a failure mode. In addition, the RTM process reduces fabrication labor, reduces scrap and the need for secondary machining and provides lowered overall nozzle cost due to the ability to produce near net shape performs.

The use of benzoxazine resin in the RTM process provides further advantages, including compatibility of the resin with high levels of vacuum prior to RTM and during the RTM process, and viscosity stability at the RTM machine process temperatures (100-275° F.). Benzoxazine resin provides reasonable cure profiles consistent with high rate production requirements for low cost. This is the need to cure within a few hours while on the expensive matched metal RTM mold. The benzoxazine resin also provides compatibility with the silica fiber and the fabric finish on the silica fiber.

### EXAMPLE

A composite structure was fabricated using benzoxazine resin (Epsilon 99110) and silica fabric in a vacuum RTM process.
1. A vacuum of 0.2 mmHg was applied to the 99110 while agitating to remove residual air and other volatiles.
2. The resin tank was heated repeatedly to 125° F. for degassing without significant viscosity increase. At 125° F. the viscous 99110 resin is very easy to dispense by the automated servo driven RTM machine.
3. A cure profile in the RTM mold of 90 minutes at 355° F. was used.
4. Exhibited compatibility with silica fabric.

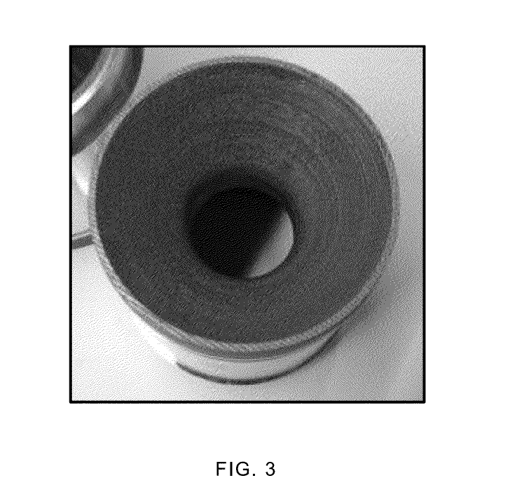

FIG. 3 is a photograph of the composite manufactured using Epsilon 99110 Benzoxazine/Silica Fiber—120 layers of 25 mil fabric, approximately 55% fiber volume.

Epsilon 99110 benzoxazine resin is very stable at process temperature and very easy to RTM. The benzoxazine resin contains very little to zero volatiles as received. The thick nature of the silica preform allows for low pressure RTM. Excellent laminate quality was obtained. No thick laminate run away exotherm was observed.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A method of producing a composite rocket motor nozzle comprising:
forming a near net shape three-dimensional preform comprising a first reinforcement material in a first region and a second reinforcement material in a second region, the first reinforcement material being different than the second reinforcement material;
positioning the three-dimensional preform in a mold cavity of a mold;
introducing a matrix resin into the preform within the mold cavity and molding the preform and the resin to form the composite rocket motor nozzle having a final shape and final dimensions.

2. The method of claim 1, further comprising positioning a solid nozzle throat insert within the mold cavity prior to introducing the matrix resin.

3. The method of claim 1, wherein the first reinforcement material comprises silica fiber or ceramic fiber.

4. The method of claim 1, wherein the second reinforcement material comprises carbon fiber.

5. The method of claim 1, wherein the matrix resin comprises benzoxazine.

6. The method of claim 1, wherein a fiber angle and fiber volume of the first reinforcement material in the first region is selected independently of a fiber angle and fiber volume of the second reinforcement material in the second region.

7. A composite rocket motor nozzle produced in accordance with the method of claim 1.

8. A near net shape composite rocket motor nozzle precursor comprising:
a three-dimensional nozzle preform portion formed of a resin impregnable first reinforcement material;
a three-dimensional dome preform portion formed of a resin impregnable second reinforcement material;
an annular narrow throat preform portion between the nozzle portion and the dome portion, the throat portion formed of a resin impregnable third reinforcement material and configured to accept a solid throat insert; and
a solid throat insert positioned inside of the narrow throat preform portion;
wherein at least two of the first reinforcement material, second reinforcement material and third reinforcement material comprise different fiber material.

9. The precursor of claim 8, further comprising a metal housing surrounding the nozzle preform portion, the dome preform portion and the throat preform portion.

10. The precursor of claim 8, wherein the first reinforcement material comprises silica fiber or ceramic fiber.

11. The precursor of claim 8, wherein the second reinforcement material comprises silica fiber or ceramic fiber.

12. The precursor of claim 8, wherein the third reinforcement material comprises carbon fiber.

13. The precursor of claim 8, wherein the solid throat insert is constructed of silicon carbide or tungsten.

14. The precursor of claim 8, wherein a fiber angle and fiber volume of the nozzle preform portion is selected independently of a fiber angle and fiber volume of the throat preform portion and a fiber angle and fiber volume of the dome preform portion.

15. The precursor of claim 8, wherein a fiber angle and fiber volume of the dome preform portion is selected independently of a fiber angle and fiber volume of the throat preform portion and a fiber angle and fiber volume of the nozzle preform portion.

16. A composite rocket motor nozzle comprising:
a nozzle portion comprising silica or ceramic fibers in a benzoxazine matrix;
a narrow throat portion comprising carbon fibers in a benzoxazine matrix; and
a dome portion comprising silica or ceramic fibers in a benzoxazine matrix;
wherein the nozzle portion, the throat portion and the dome portion are simultaneously molded in a resin transfer molding process to form a single composite rocket motor nozzle structure.
